(19) United States
(12) Patent Application Publication
(10) Pub. No.: US 2026/0295432 A1
(43) Pub. Date: Oct. 1, 2026

(54) GAMIFIED SINGLE PLAYER CHARISMA AND/OR CHARM EVALUATION

(71) Applicant: Tinder LLC, Dallas, TX (US)

(72) Inventors: William L. Wu, West Hollywood, CA (US); Thomas J. Purtell, West Hollywood, CA (US); Yu Lu, Los Angeles, CA (US); Angelo Alduino, New York City, NY (US); Alex Osborne, Salem, OR (US); Levi R. Eirinberg, Los Angeles, CA (US); Faye M. Iosotaluno, West Hollywood, CA (US)

(73) Assignee: Tinder LLC, Dallas, TX (US)

(21) Appl. No.: 19/635,262

(22) Filed: Mar. 31, 2026

Related U.S. Application Data
(60) Provisional application No. 63/781,221, filed on Mar. 31, 2025.

(51) Int. Cl. A63F 13/67; A63F 13/215; A63F 13/54; A63F 13/79; G06N 3/0475; G06Q 10/40

(52) U.S. Cl. CPC A63F 13/67; A63F 13/215; A63F 13/54; A63F 13/79; G06N 3/0475; G06Q 10/40

(57) ABSTRACT

Particular example embodiments described herein can provide for a system, an apparatus, and a method to help enable a gamified single player charisma and/or charm evaluation. In an example, the system, apparatus, and method can create a scenario for a user, wherein the user engages in conversation with an AI generated persona, monitor the user's interaction with the AI generated persona, and determine a charisma and/or charm of the user based on the monitored user's interaction with the AI generated persona.

### CROSS-REFERENCE TO RELATED APPLICATIONS

This Application claims the benefit of priority under 35 U.S.C. § 119 of U.S. App. Ser. No. 63/781,221, filed on Mar. 31, 2025, entitled “GAMIFIED SINGLE PLAYER CHARISMA AND/OR CHARM EVALUATION,” Inventors William L. Wu et al. The disclosure of that application is considered part of and is incorporated in its entirety by reference in the disclosure of this application.

### TECHNICAL FIELD

This disclosure relates in general to the field of information and communication technology for implementation of amusement devices and games, more particularly, to a system, an apparatus, and a method to help enable a gamified single player charisma and/or charm evaluation.

### BACKGROUND

In today's modern world, dating services are a popular way individuals meet and are the preferred method where individuals look to find friendships, casual connections, dates and other types of relationships. In a typical dating service, users have profiles about themselves to solicit the interest of other users and can view the profile of the other users.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of a system to help enable a gamified single player charisma and/or charm evaluation, in accordance with an embodiment of the present disclosure;

FIG. 1B is a simplified block diagram of a system to help enable a gamified single player charisma and/or charm evaluation, in accordance with an embodiment of the present disclosure;

FIG. 2 is a simplified block diagram of a particular implementation illustrating examples details of a user interface to help enable a gamified single player charisma and/or charm evaluation, in accordance with an embodiment of the present disclosure;

FIG. 3 is a simplified block diagram of a particular implementation illustrating examples details of a user interface to help enable a gamified single player charisma and/or charm evaluation, in accordance with an embodiment of the present disclosure;

FIG. 4 is a simplified block diagram of a particular implementation illustrating examples details of a user interface to help enable a gamified single player charisma and/or charm evaluation, in accordance with an embodiment of the present disclosure;

FIG. 5 is a simplified block diagram of a particular implementation illustrating examples details of a user interface to help enable a gamified single player charisma and/or charm evaluation, in accordance with an embodiment of the present disclosure;

FIG. 6 is a simplified block diagram of a particular implementation illustrating examples details of a user interface to help enable a gamified single player charisma and/or charm evaluation, in accordance with an embodiment of the present disclosure;

FIG. 7 is a simplified block diagram of a particular implementation illustrating examples details of a user interface to help enable a gamified single player charisma and/or charm evaluation, in accordance with an embodiment of the present disclosure;

FIG. 8 is a simplified flowchart illustrating potential operations to help enable a gamified single player charisma and/or charm evaluation, in accordance with an embodiment of the present disclosure;

FIG. 9 is a simplified flowchart illustrating potential operations to help enable a gamified single player charisma and/or charm evaluation, in accordance with an embodiment of the present disclosure;

FIG. 10 is a simplified flowchart illustrating potential operations to help enable a gamified single player charisma and/or charm evaluation, in accordance with an embodiment of the present disclosure;

FIG. 11 is a simplified flowchart illustrating potential operations to help enable a gamified single player charisma and/or charm evaluation, in accordance with an embodiment of the present disclosure;

FIG. 12 is a simplified block diagram illustrating example details of an example computer model inference and computer model training to help enable a gamified single player charisma and/or charm evaluation, in accordance with an embodiment of the present disclosure; and

FIG. 13 is a simplified block diagram illustrating examples details of an example neural network architecture to enable a gamified single player charisma and/or charm evaluation, in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, and systems relating to a gamified single player charisma and/or charm evaluation, in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

Dating services can operate on the fundamental principle of connecting individuals based on shared interests, preferences, and potential compatibility. For example, some dating services try to achieve this by leveraging a combination of user-provided information and algorithms. To use a dating application, an individual creates a profile containing information such as age, gender, location, interests, and photos. Some dating services also allow additional details like education, occupation, or lifestyle choices. Dating services often incorporate geolocation technology, enabling users to discover potential matches within a certain distance radius. This feature enhances the chances of meeting someone nearby and facilitates real-life interactions. Some individuals on dating services struggle to showcase their personality in a way that leads to meaningful connections.

Modern dating services often have room for growth in sparking genuine self-expression, surfacing personal compatibility, and reducing the anxiety of starting, what could be otherwise challenging in-person conversations. For instance, users may struggle to showcase personality in a way that leads to meaningful connections, while some may experience fatigue from repetitive swiping and generic profiles.

A system, method, apparatus, means, etc. can address these issues by introducing an interactive, gamified experience that encourages users to express themselves through playful prompts and scenarios. The system, method, apparatus, means, etc. can help surface core personality traits, confidence styles, and dating intentions in a format that feels fun and low stakes. The result is higher engagement, better self-insight, and improved compatibility signals between matches, solving for both user hesitancy and stronger conversation starters.

In an example, the system, method, apparatus, means, etc. can include a dynamic, AI-driven gamified dating scenario that uses real-time interactions to surface personality insights and enhance user expression. The real-time interactions can be voice based and/or text based. In an illustrative example, a user is placed into a hypothetical, unexpected scenario and attempts to showcase their charisma, charm, and adventure, among other traits, in an effort to earn a date. Built on top of multiple AI models, the experience simulates a playful, back-and-forth dialogue where users respond to creative scenarios, choices, and challenges designed to reveal their confidence, style, humor, values, and dating vibe. In some examples, the AI models are tuned using administrator feedback in prompts to guide the tuning of the AI model. Unlike static profile fields or gesture-based interactions, the system, method, apparatus, means, etc. can help create an entertaining, personalized layer of self-expression.

In a specific illustrative example, the system, method, apparatus, means, etc. can include a real-time, AI-powered interactive feature integrated within an online dating service, such as a dating website or application. Some implementations of the present disclosure simulate spontaneous, voice-based social encounters where users are challenged to demonstrate charisma, charm, quick thinking, and interpersonal skill, commonly referred to, but not limited only to, as “rizz.” The experience can present users with immersive, hypothetical scenarios in which they engage in a back-and-forth conversation with a fully voiced, AI-powered character (an “AI persona” or digital character). The objective of an interaction can be to persuade the digital character to agree to a fictional date, which serves as a proxy for social skill evaluation and expression. In some examples, the social encounters can be text based such as to accommodate hearing impaired users.

### Example Systems, Apparatuses, and Methods

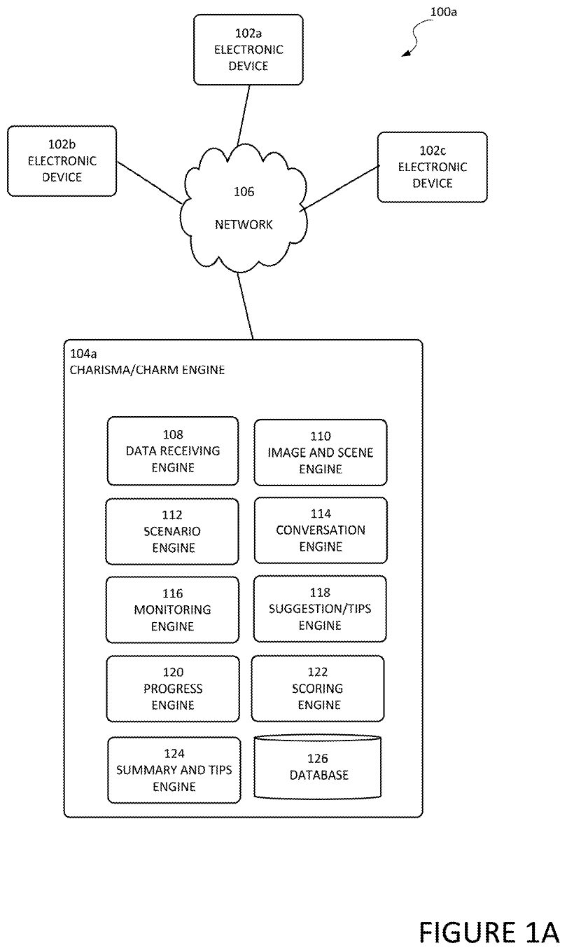

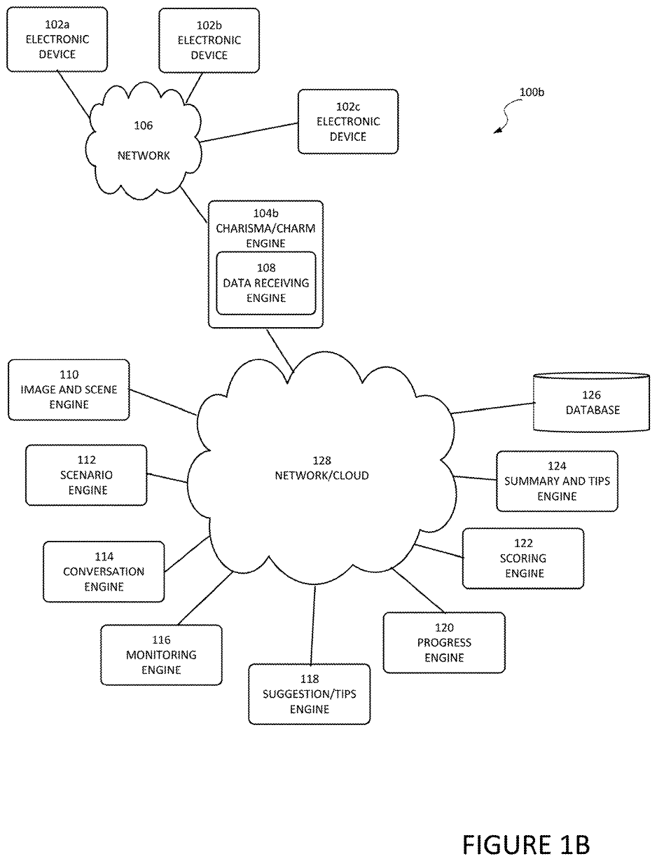

FIGS. 1A and 1B are simplified block diagrams of a particular non-limiting system 100 to help enable a gamified single player charisma and/or charm evaluation. As illustrated in FIG. 1A, a system 100a can include one or more electronic devices 102 and a charisma/charm engine 104a. The one or more electronic devices 102 and the charisma/charm engine 104 can be in communication with each other using network 106. The charisma/charm engine 104 can include a data receiving engine 108, an image and scene engine 110, a scenario engine 112, a conversation engine 114, a monitoring engine 116, a suggestion/tips engine 118, a progress engine 120, a scoring engine 122, a summary and tip engine 124, and a database 126.

As illustrated in FIG. 1B, a system 100b can include one or more electronic devices 102 and a charisma/charm engine 104b. The one or more electronic devices 102 and the charisma/charm engine 104b can be in communication with each other using network 106. The charisma/charm engine 104b can include the data receiving engine 108. Also, the charisma/charm engine 104b can be in communication with the data receiving engine 108, the image and scene engine 110, the scenario engine 112, the conversation engine 114, the monitoring engine 116, the suggestion/tips engine 118, the progress engine 120, the scoring engine 122, the summary and tip engine 124, and the database 126 using a network/cloud 128.

Note that one or more of the image and scene engine 110, the scenario engine 112, the conversation engine 114, the monitoring engine 116, the suggestion/tips engine 118, the progress engine 120, the scoring engine 122, the summary and tip engine 124, and the database 126 may be located in the charisma/charm engine 104. Also, one or more of the data receiving engine 108, the image and scene engine 110, the scenario engine 112, the conversation engine 114, the monitoring engine 116, the suggestion/tips engine 118, the progress engine 120, the scoring engine 122, the summary and tip engine 124, and the database 126 may be located outside of the charisma/charm engine 104 and in communication with the charisma/charm engine 104 using a network connection. In some examples, one or more of the image and scene engine 110, the scenario engine 112, the conversation engine 114, the monitoring engine 116, the suggestion/tips engine 118, the progress engine 120, the scoring engine 122, the summary and tip engine 124, and the database 126 are located in a cloud.

The data receiving engine 108 can be configured to receive and communicate data to and from the charisma/charm engine 104. The image and scene engine 110 can be configured to generate an avatar and scene for a scenario created by the scenario engine 112. In some examples, the image and scene engine 110 can be configured to create a custom or unique image for each game played by a user and/or each round of a game played by the user. In some examples, the image and scene engine 110 can create animated images and/or scenes. In a specific example, the animated images and/or scenes are based on or in reaction to the progress of the user as the user plays the game and engages with the digital character.

The scenario engine 112 can be configured to create a scenario or situation that is used to engage with a user. The conversation engine 114 can be configured to engage in conversation or dialog with the user. The monitoring engine 116 can be configured to monitor the conversation or dialog with the user to ensure the user is engaging with the digital character in a healthy manner (e.g., the user is not hostile or belligerent; the user is not displaying signs of depression or suicidal ideation). The suggestion/tips engine 118 can be configured to monitor the progress of the user during the conversation or dialog and provide suggestions or tips to the user on how to improve their charisma/charm or rizz. The progress engine 120 can be configured to monitor the progress of the user during the conversation or dialog and provide real time or near real time feedback to the user. The scoring engine 122 can be configured to monitor the progress of the user during the conversation or dialog and determine a score or level that summarizes how well the user did during the conversation or dialog. The summary and tip engine 124 can be configured to monitor the progress of the user during the conversation or dialog and, at the conclusion of the conversation or dialog, provide a summary of how well the user performed and provide feedback or tips for the user to improve their performance. One or more of the image and scene engine 110, the scenario engine 112, the conversation engine 114, the monitoring engine 116, the suggestion/tips engine 118, the progress engine 120, the scoring engine 122, and the summary and tip engine 124 may include an AI system, computer model, use AI computer, and/or use machine learning. The database 126 can store transcripts, scores, prompts, token usage, cost data, and other data. In some examples, the data is de-identified after session completion to protect the privacy of users.

In some specific non-limiting examples, upon initiation, the user is presented with a fictional scenario that sets the context for the interaction (e.g., meeting at a concert, spilling coffee at a bookstore). The scenario can be selected from a pre-defined set, each tagged with a difficulty level (e.g., easy, medium, or hard). In some implementations, the gender and style of the digital character are customized based on the user's dating preferences.

In a specific non-limiting example, the system architecture leverages a language model via a real-time application programming interface (API) to power the digital character's spoken responses, scenario understanding, real-time dynamic hints, and interaction scoring. Digital characters can be procedurally generated with randomized attributes including name, age, job, accent, voice, and personality traits. The character can adopt a consistent identity and roleplay throughout the session without breaking character. Sessions can be managed using, for instance, LiveKit's web real-time communication (WebRTC) infrastructure, which handles low-latency, real-time voice streaming between the user and the AI.

After launching the scenario, the user participates in a timed, voice-based dialogue. The digital character can respond in real time using speech synthesized from text generated by a generative pre-trained transformer (GPT). The conversation can be analyzed by the backend using the language model for real-time judgment and scoring. User responses can be scored across categories, such as, but not limited to, wit, empathy, confidence, creativity, courtesy, etc. If a user underperforms, the system can generate real-time suggestions to help improve the interaction.

The session culminates in an aggregate “Rizz Score.” In some examples, the Rizz Score is visualized (e.g., via flames or other indicator). Users can receive a session summary that includes their scores, key feedback, a sharable AI-generated recap, and a stylized portrait of the digital character. In some examples, the digital character can be generated via a multi-step process including image creation (e.g., from text prompts) and human curation. The summary can be shared through native OS share sheets.

Backend components include orchestrators that manage scenario generation (e.g., the scenario engine 112), image and scene construction (e.g., the image and scene engine 110), scoring logic (e.g., the scoring engine 122), voice interaction sessions (e.g., the conversation engine 114), analytics (e.g., the summary and tips engine 124), etc. AI Prompts can be structured to help ensure entertaining and challenging roleplay, including guardrails to prevent the AI from breaking character or offering unsolicited dates. An agent service can coordinate voice sessions, with session metrics tracked through dashboards or some other session metrics system for real-time monitoring. Session logging or some other system of logging or storing data can store transcripts, scores, prompts, token usage, and cost data, de-identified after session completion (e.g., in database 126).

Unlike existing static or text-based dating features, the system introduces a fully voice-interactive, scenario-based game layer into the dating experience. It turns AI roleplay into an emotionally resonant and skill-testing mini-game by blending personalization, performance pressure, and fun. The integration of a real-time model for both interaction and judgment, combined with personalized avatars, scenario-driven social dynamics, and gamified scoring, can help create a novel format for personality expression and social discovery in dating.

Previous attempts to address personality expression and user engagement in dating apps have primarily relied on static formats such as written profile prompts, photo carousels, personality quizzes, or swipe-based preference filters. Some apps have experimented with lightweight games or Q&A modules to facilitate better conversation starters, while others have incorporated short-form video or audio clips for self-expression. However, these approaches lack real-time interactivity, adaptive feedback, or deep personalization, and often fail to capture the nuance of human charm, humor, and conversational skill.

General-purpose AI companions or chatbots are typically text-based, 1:1 messaging experiences, not multiplayer-facing, gamified, or tied to a dating context. The system introduces a real-time, voice-based, scenario-driven interaction where users are challenged to demonstrate “rizz” or a blend of confidence, wit, and emotional intelligence in fictional dating encounters. Live AI Voice Interaction can be achieved using low-latency audio infrastructure (e.g., a Realtime API and LiveKit) to simulate spontaneous conversation. This voice interaction adds authenticity and immediacy to the experience, unlike text-based agents or pre-recorded bots. Each session can include live feedback, scoring across interpersonal traits, and a final rating that helps users understand their social performance to help blend utility with playfulness. Digital characters can be generated with varied accents, personalities, and backstories, tailored to the user's preferences, making each session feel unique and highly personal. These features, and other features, combine to help create an experience that is dynamic, culturally resonant, and emotionally expressive. The system can help turn the act of flirting into a challenge and form of entertainment, unlocking new surface area for engagement, self-discovery, and shareability.

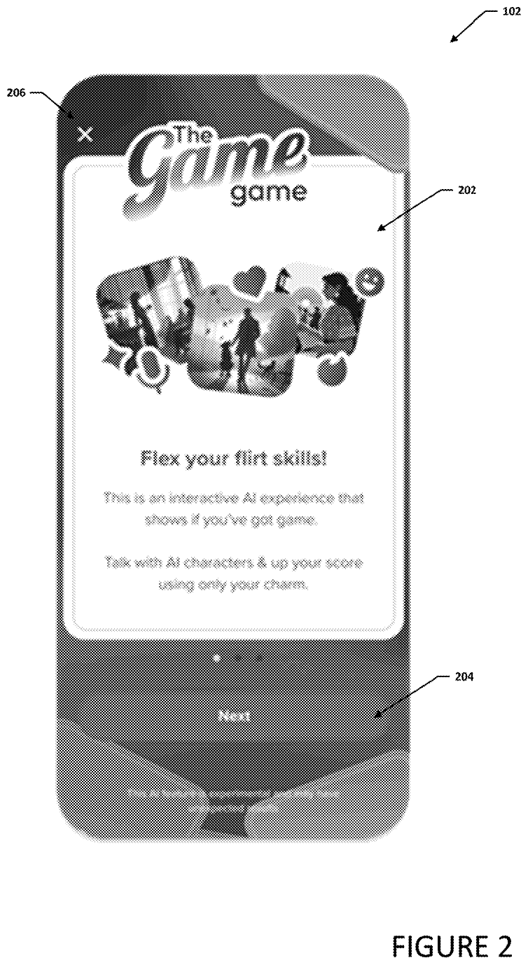

Turning to FIG. 2, FIG. 2 is a simplified block diagram illustrating example details of a particular non-limiting illustrative example of a new user onboarding screen 202. As illustrated in FIG. 2, the electronic device 102 can include the onboarding screen 202. The electronic device 102 can be a computer, a personal digital assistant (PDA), a laptop or electronic notebook, hand held device, a cellular telephone, a smartphone, an IP phone, wearables, satellite communication device, or any other device, component, element, or object that is enabled to allow a user to interact with the system 100. The onboarding screen 202 is an illustrative example of a first screen presented to a user when a user is first interacting with the system 100. Tapping or selecting a next icon 204 will forward the user in the experience. Tapping or selecting an X icon 206 will dismiss the experience and take users back to a home screen.

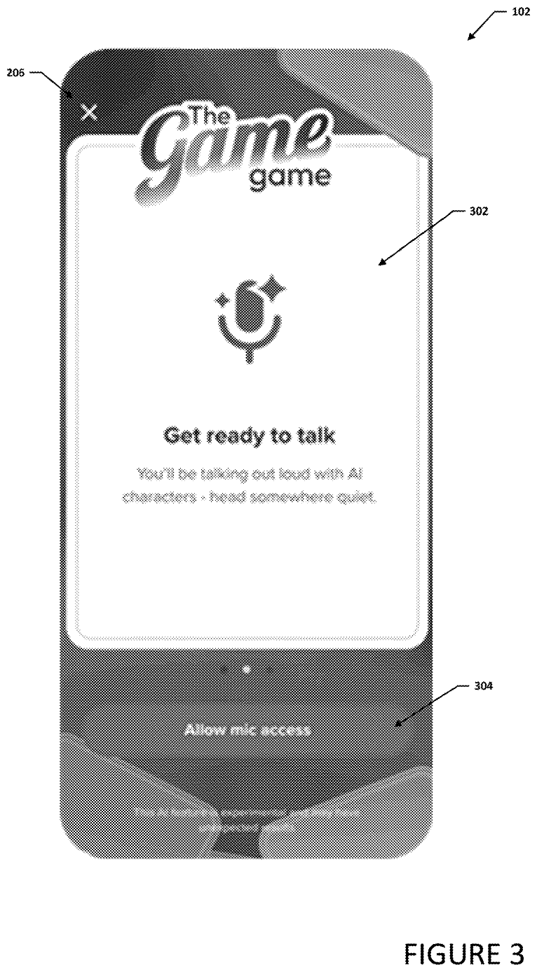

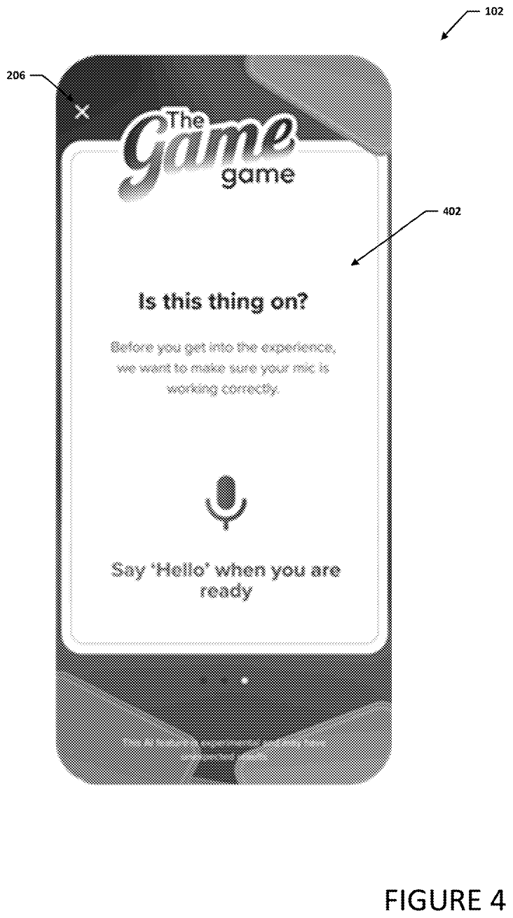

Turning to FIG. 3, FIG. 3 is a simplified block diagram illustrating example details of a particular non-limiting illustrative example of a new user microphone onboarding screen 302. As illustrated in FIG. 3, the electronic device can include the microphone onboarding screen 302. From the microphone onboarding screen 302, the user can tap or select the allow mic access icon 304 to allow the system to access the microphone of the electronic device 102. If the user previously had rejected or turned off their microphone access, the user can be taken to the electronic device's microphone section in settings to turn on microphone access. After allow microphone access, the user can be taken to a next ‘Test your mic’ screen, illustrated in FIG. 4. Tapping or selecting an X icon 206 will dismiss the experience and take users back to a home screen.

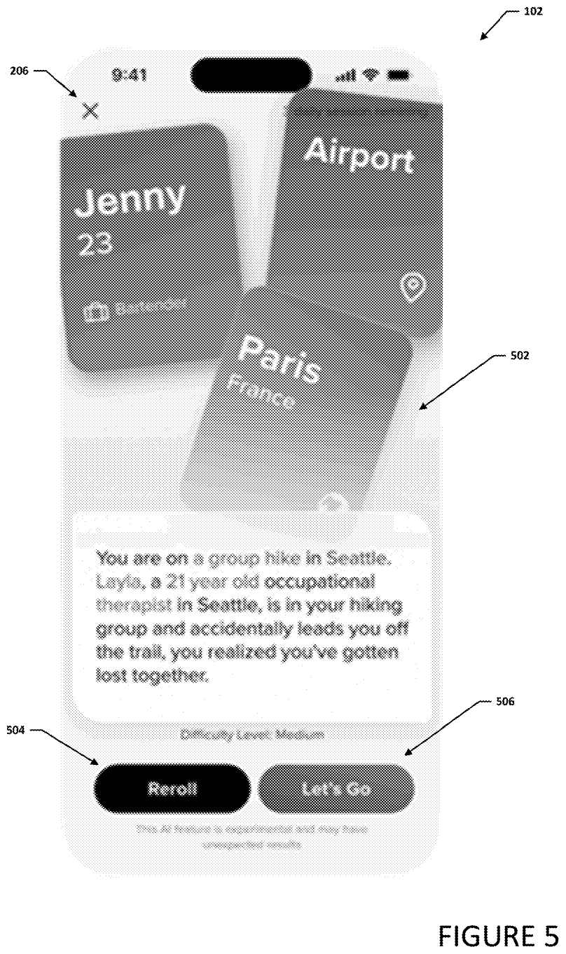

Turning to FIG. 4, FIG. 4 is a simplified block diagram illustrating example details of a particular non-limiting illustrative example of a microphone testing screen 402. As illustrated in FIG. 4, the electronic device 102 can include the microphone testing screen 402. Using the microphone testing screen 402, the user will need to speak or say a word in order to move forward in the experience. The user should be clearly audible for a successful mic test. If a user does not say anything (e.g., for more than 5 seconds), the system can remind the user to speak using visual and/or haptic feedback. If a user says something but it is not clear or has background noise, the system can ask the user to retry in a quieter place. Once user successfully tests the mic, a scenario generation screen 502, illustrated in FIG. 5, can presented to the user. Tapping or selecting an X icon 206 will dismiss the experience and take users back to a home screen.

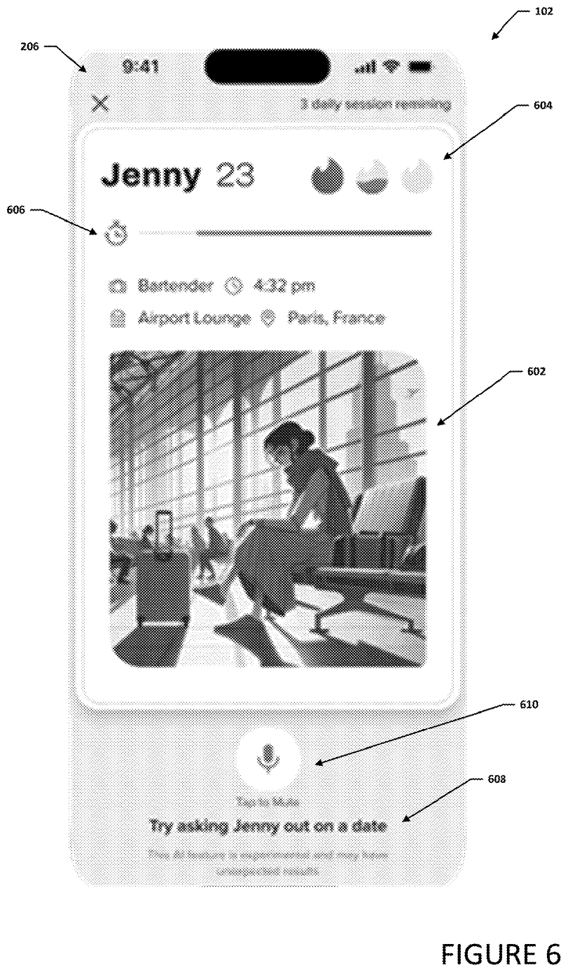

Turning to FIG. 5, FIG. 5 is a simplified block diagram illustrating example details of a particular non-limiting illustrative example of a scenario generation screen 502. As illustrated in FIG. 5, the electronic device 102 can include the scenario generation screen 502. The scenario generation screen 502 presents the user with a hypothetical situation. In some examples, text can provide contextual information to help users understand the generated scenario. The AI persona's gender in the generated scenario should be selected based on the user's gender and sexual orientation preferences. The scenario can explain the situation in which the AI and the user are meeting to set the stage for the conversation. In some examples, a difficulty tag can be displayed that suggests if the scenario is easy, medium or hard difficulty level. If the user taps or selects a reroll icon 504, a new scenario for the user can be generated. If the user taps or selects a let's go icon 506, a scenario screen 602, illustrated in FIG. 6, can be presented to the user. Tapping or selecting an X icon 206 will dismiss the experience and take users back to a home screen.

Turning to FIG. 6, FIG. 6 is a simplified block diagram illustrating example details of a particular non-limiting illustrative example of a scenario screen 602. As illustrated in FIG. 6, the electronic device 102 can include the scenario screen 602. The main activity on the scenario screen 602 is that the AI agent starts talking and then the user is meant to respond, starting a back-and-forth conversation that lasts for 1-3 minutes. The same information about the AI persona that the user sees on scenario generation screen 502, illustrated in FIG. 5, can also be presented on the scenario screen 602 during the audio session. More specifically, the AI persona's name, age, occupation, time, and location can be displayed, and AI generated images of the AI persona to the user can be displayed on the scenario screen 602. In some examples, the user's aggregate score, illustrated by flames 604 and a countdown timer 606 can also be displayed to the user on the scenario screen 602. The countdown timer 606 can show an approximation of how much time is remaining in the session.

In some examples, real-time suggestions 608 may appear below a mute button 610 or some other location on the scenario screen 602. Using the real-time suggestions 608 and based on the scenario, prompt and overall progress, the user can be provided with some guidance about what they could do to move the session forward. The user can tap on the mute button 610 to mute and tap again to unmute.

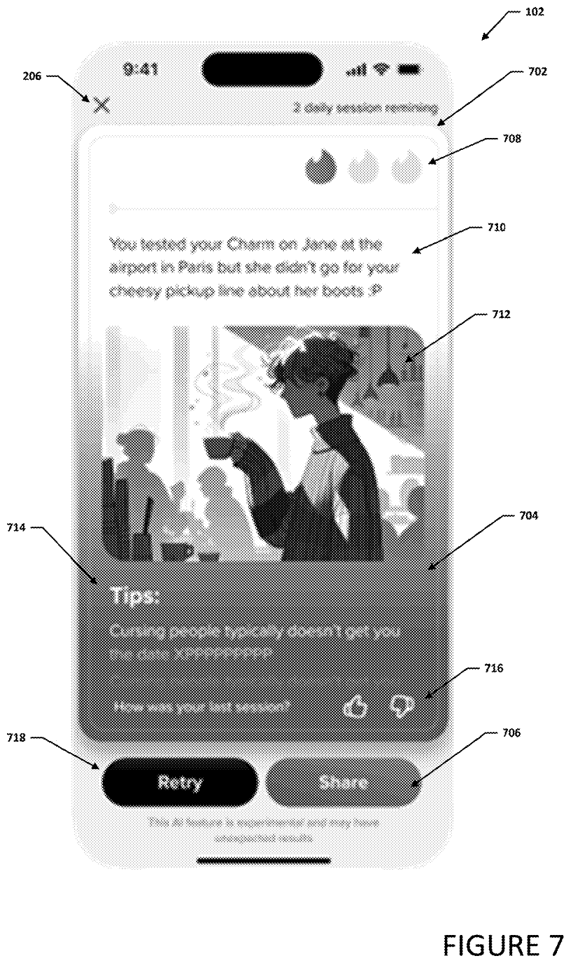

From the scenario screen 602, the user can talk to the AI persona in a back-and-forth conversation for the duration of the session. Round by round scores may appear after each user response and depending on the analysis, and the user can be given a score across a few different criteria to reinforce the digital character's reaction to a previous comment. In some examples, when the digital character talks, a portion of the scenario screen 602 (e.g., the bottom portion) can animate a shade of red to blue to indicate to the user that the AI is talking and to communicate mood of the AI persona. After time for the session has expired, the user is taken to a summary screen 702, illustrated in FIG. 7. Tapping or selecting an X icon 206 will dismiss the experience and take users back to a home screen.

Turning to FIG. 7, FIG. 7 is a simplified block diagram illustrating example details of a particular non-limiting illustrative example of a summary screen 702. As illustrated in FIG. 7, the electronic device can include the summary screen 702. When the user completes a session the summary screen 702 can display a summary card 704 that the user can share by tapping or selecting a share icon 706.

The summary screen 702 can also display an aggregate score (e.g., flames) 708 for the session, an AI generated summary of the session 710, an AI generated illustration 712 that may capture the mood or results of the session, AI generated tips 714 on how the user can improve, and other details about the session. In some examples, tapping or selecting a thumbs up or thumbs down icon 716 can help the user provide a rating and feedback about the session and system 100.

In some examples, the user can retry the session by tapping or selecting a retry icon 718. In some specific examples, the user may have a limited number of times they can experience a session (e.g., three times a day). If user has daily sessions remaining, tapping or selecting the retry icon 718 will take the user back to the scenario screen 602 illustrated in FIG. 6, and start a new session. If the user has exhausted sessions for the day, the electronic device 102 can display a ‘ran out of sessions’screen. The daily sessions can reset midnight 12:00 AM User Time Zone. In some examples where the user has a limited number of times they can experience a session, upon tapping or selecting the let's go icon 506 illustrated in FIG. 5, the user session is decremented by 1.

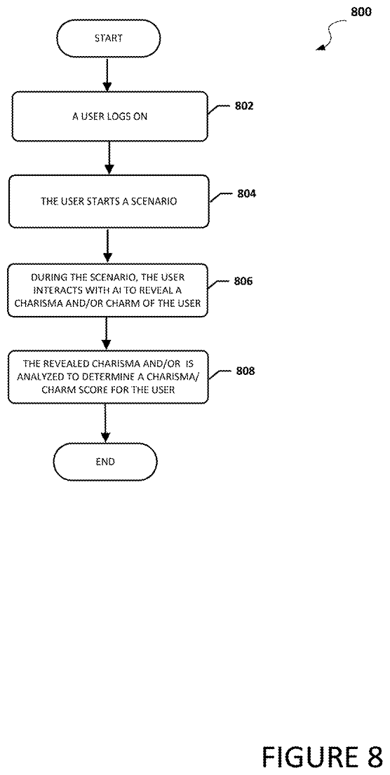

Turning to FIG. 8, FIG. 8 is an example flowchart illustrating possible operations of a flow 800 that may be associated with potential operations to help enable a gamified single player charisma and/or charm evaluation, in accordance with an embodiment of the present disclosure. Specifically, in some examples, one or more operations of flow 800 may be performed by the charisma/charm engine 104b, the data receiving engine 108, the image and scene engine 110, the scenario engine 112, the conversation engine 114, the monitoring engine 116, the suggestion/tips engine 118, the progress engine 120, the scoring engine 122, and/or the summary and tip engine 124.

At 802, a user logs onto the system. In some examples, the user is authenticated. In some examples, the system is a dating application. At 804, the user starts a scenario. For example, the user can start a scenario as explained with reference to FIGS. 5 and 6. At 806, during the scenario, the user interacts with a computer model or AI to reveal a charisma and/or charm of the user. At 808, the revealed charisma and/or charm of the user is analyzed to determine a charisma/charm score for the user.

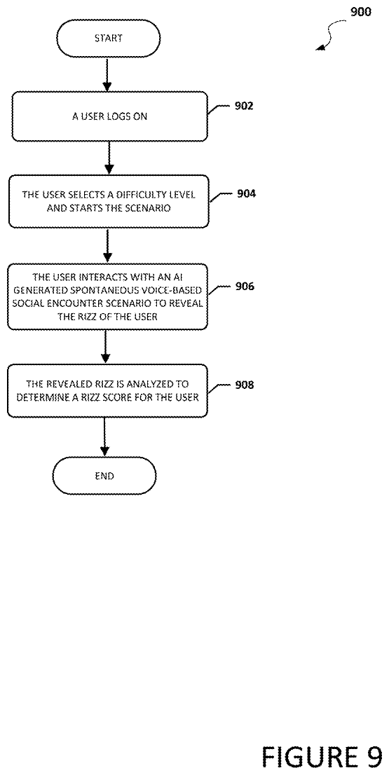

Turning to FIG. 9, FIG. 9 is example flowchart illustrating possible operations of a flow 900 that may be associated with potential operations to help enable a gamified single player charisma and/or charm evaluation, in accordance with an embodiment of the present disclosure. Specifically, in some examples, one or more operations of flow 900 may be performed by the charisma/charm engine 104b, the data receiving engine 108, the image and scene engine 110, the scenario engine 112, the conversation engine 114, the monitoring engine 116, the suggestion/tips engine 118, the progress engine 120, the scoring engine 122, and/or the summary and tip engine 124.

At 902, a user logs onto the system. In some examples, the user is authenticated. In some examples, the system is a local application for an online dating service. At 904, the user selects a difficulty level and starts a scenario. For example, the user can start a scenario as explained with reference to FIGS. 5 and 6. At 906, the user interacts with a computer model or AI generated spontaneous voice-based social encounter scenario to review the rizz of the user. At 908, the revealed rizz of the user is analyzed to determine a rizz score for the user.

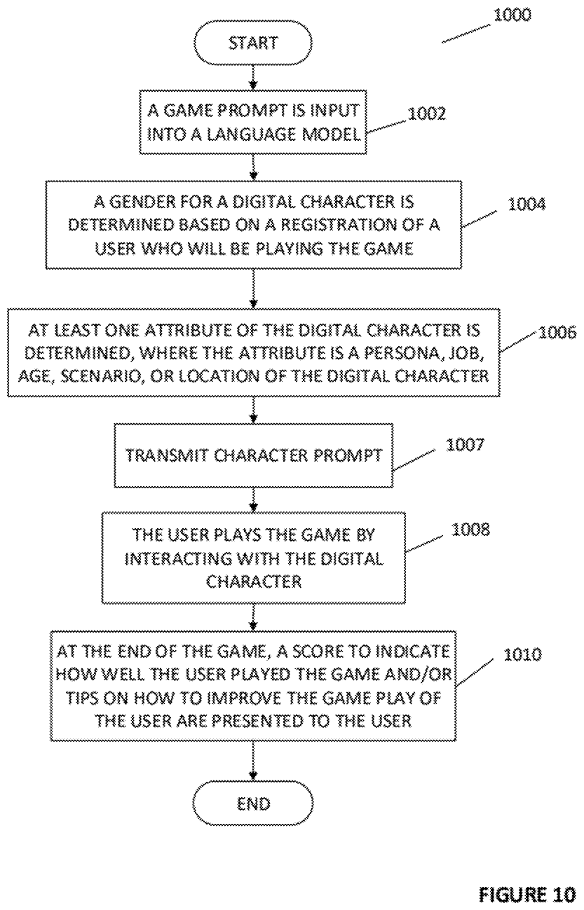

Turning to FIG. 10, FIG. 10 is an example flowchart illustrating possible operations of a flow 1000 that may be associated with potential operations to help enable a gamified single player charisma and/or charm evaluation, in accordance with an embodiment of the present disclosure. Specifically, in some examples, one or more operations of flow 1000 may be performed by the charisma/charm engine 104b, the data receiving engine 108, the image and scene engine 110, the scenario engine 112, the conversation engine 114, the monitoring engine 116, the suggestion/tips engine 118, the progress engine 120, the scoring engine 122, and/or the summary and tip engine 124.

At 1002, a game prompt including a goal for a game is input into an LLM. The game prompt can include instructions to the LLM regarding the game. The game prompt can identify a language in which to converse with users. The game prompt can indicate a length of reply, such as one or two sentences. The instructions can include an affirmative instruction (e.g., “You are a participant in a dating role playing game.”) or a negative instruction (e.g., “You should not ask them out.”) The instructions can include adverbs of frequency, such as “always” or “never.” The instructions can also include a level of difficulty and a number of scenarios.

At 1004, a gender for a digital character is determined based on a registration of a user who will be playing the game. For example, a user registration for the online dating service can be received, where the registration includes an indication of a gender of interest for the user. At 1006, at least one attribute of the digital character is determined, where the at least one attribute is a persona, job, age, scenario, or location of the digital character. The persona can include, for example, a name, an accent, and the gender for the digital character. The scenario can be, for example, a costume party or other scenario as described below. The location can include a city or region. In some examples, the at least one attribute of the digital character is determined randomly.

The persona can also identify a real person or a fictional entity. An example of a real person can be a comedian or comedienne. An example of a persona of a fictional entity is a storybook character, a character in a video, a virtual character (such as, but not limited to, Kasane Teto), a video game character, or a cartoon character.

At 1007, a character prompt is input to the LLM. The character prompt can include the at least one attribute. In some implementations, the character prompt can include a level of difficulty for the game.

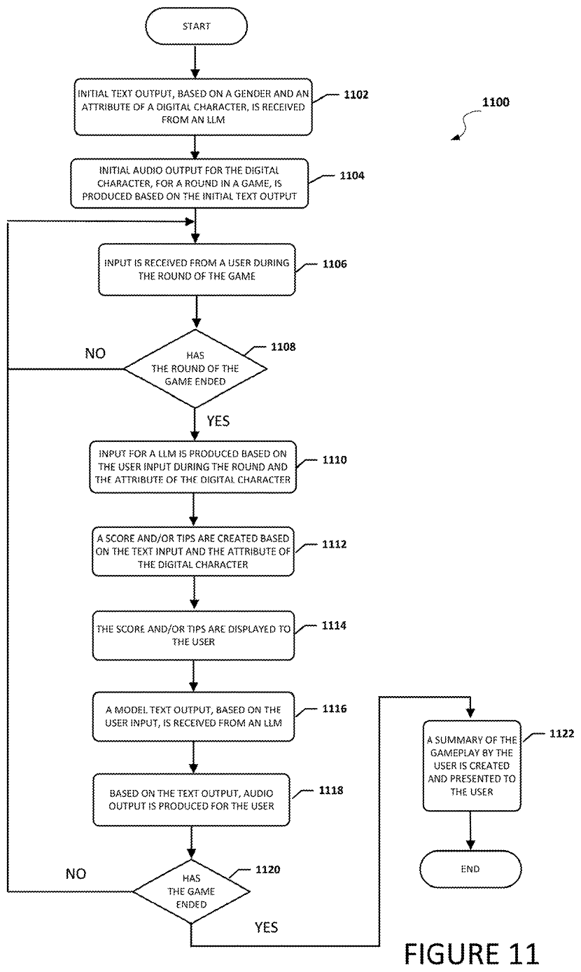

At 1008, the user plays the game by interacting with the digital character. The operations of 1008 are set forth in more detail in FIG. 11. At 1010, at the end of the game, a score to indicate how well the user played the game and/or tips on how to improve the game play of the user are displayed to the user. In some examples, the goal of the game is to have the digital character accept a date from the user, and the score indicates how close the user was to having the digital character accept a date from the user. Further, the tips can include tips or suggestions that may help the user have the digital character accept a date from the user.

The game prompt or the character prompt can identify an emotion to be conveyed by the digital character. In an implementation in which the character prompt indicates the emotion, the emotion can be indicated by the at least one attribute. Thus, for example, the emotion can be determined based on a profile of the user or randomly.

Further, the game prompt or character prompt can reflect a particular cultural reference, such as a movie or book.

Turning to FIG. 11, FIG. 11 is an example flowchart illustrating possible operations of a flow 1100 that may be associated with potential operations to help enable a gamified single player charisma and/or charm evaluation, in accordance with an embodiment of the present disclosure. Specifically, in some examples, one or more operations of flow 1100 may be performed by the charisma/charm engine 104b, the data receiving engine 108, the image and scene engine 110, the scenario engine 112, the conversation engine 114, the monitoring engine 116, the suggestion/tips engine 118, the progress engine 120, the scoring engine 122, and/or the summary and tip engine 124.

At 1102, an initial text output, based on a gender and an attribute of a digital character, is received from an LLM. At 1104, an initial audio output for the digital character, for a round in a game, is produced based on the initial text output. At least one of the initial text output and the initial audio output can be received at an intermediary server, for example. At 1106, an input is received at the intermediary server from a user during the round of the game. At 1108, the system determines if the round of the game has ended. If the round of the game has not ended, more input is received from the user during the round of the game, as in 1106.

If the round of the game has ended, the intermediary server can produce input for the language model based on the user input received during the round and the attribute of the digital character, as in 1110. In some examples, the LLM is the same LLM that generated the text output in 1102. In some examples, the LLM is a different LLM from the one that generated the text output in 1102. At 1112, a score and/or tips are created based on the text input and the attribute of the digital character. At 1114, the score and/or tips are displayed to the user. At 1116, a model text output, based on the user input, is received from an LLM. In some examples, the LLM is the same LLM that generated the text output in 1102 and/or 110. In some examples, the LLM is a different LLM from the one that generated the text output in 1102 and 110. At 1118, based on the text output, audio output is produced for the user. At 1120, the system determines if the game has ended. If the game has not ended, a new round is started and input is received from a user during the new round of the game, as in 1106. If the round has ended, a summary of the gameplay by the user is created and presented to the user, as in 1122.

### Non-Limiting Example Details

In some examples, the gender of the digital character during the scenario is determined by the user's settings on the dating service. If the user has selected non-binary matches, then the character prompt can instruct the language model to act as a non-binary person. The non-binary digital characters can take on a male or female voice randomly. Otherwise, they will be given male or female personas. Scenario photos can be provided for game options based on the character prompt. In many implementations, the character prompt can include the user's gender to make the interaction seem more natural. By identifying the user as male or female, if the user has selected one of those, less common scenarios in the training dataset can be avoided.

In a specific example, there is a different predetermined scenario in each of three levels of difficulty. Some implementations can include more or fewer predetermined scenarios, as well as more or fewer levels of difficulty. Name, age, accent, job and location are selected randomly. The location may be chosen from a list based on scenario or accent for consistency. For hard difficulty, the scenario involves the user doing something that would upset the AI, and the AI reacting to that, starting from an upset state. Some non-limiting example scenarios as phrases include:
Cafe—Grabbed the wrong coffee order
Bus stop—Bumped into someone, dropped their phone
Bookstore—Knocked over a stack of books
Dog park—Dog interrupted someone's dog
Theater—Spilled popcorn on someone
Concert—Bumped into someone while dancing
Mall—Walked into someone while on phone
Restaurant—Ate someone else's food order
Market—Knocked over a stack of fruit
Laundromat—Took someone else's laundry
Escalator—Backed into someone
Lecture—Knocked over a water bottle
Food stand—Took the last item someone wanted
Sunset—Stepped in front of someone's camera
Gym—Dropped water bottle near treadmill
Conference—Spilled coffee on important papers
Train—Fell asleep on someone's shoulder
Dinner party—Insulted a dish made by someone
Art gallery—Spilled drink on artwork
Cooking class—Used someone's ingredients
Dance class—Stepped on someone's toes
House party—Broke someone's gifted vase
Beach—Stepped on and broke sunglasses
Escape room—Made a mistake that locked everyone in
Wine tasting—Spilled wine on someone's outfit
Skiing—Knocked someone over while skiing
Party—Mistaken identity due to costume
Hiking—Led someone off the trail, got lost
Cooking competition—Swapped ingredients, ruined dish

The medium difficulty scenarios have an impatient AI that is in an annoying situation with the user. Some non-limiting example scenarios as phrases include:
Ticket line—Stuck in a long line for concert tickets
Food court—Only one table left in a packed food court
Grocery store—Reaching for the same shopping basket
Elevator—Waiting for a slow elevator together
Gym—Both reaching for the same dumbbell
Taxi—Competing for the same taxi
Wedding—Awkwardly standing next to each other at a wedding bar
Theme park—Ride breaks down while waiting in line
Airport-Mixed—up luggage after leaving the terminal
Happy hour—Last two people left at an office happy hour
Amusement park—Stuck high up on a broken-down ride
Elevator Confession—Stuck in an elevator, someone blurts out an embarrassing secret
Wedding Crasher—Helping someone blend in at a wedding they weren't invited to

The easy scenarios involve the AI and the user being placed together in an activity with a suggestion of conversation. Some non-limiting example scenarios as phrases include:
Art Gallery—Discussing abstract paintings
Park—Chatting about favorite outdoor spots
Street Food Festival—Talking about adventurous eats
Farmers Market—Sharing favorite recipes
Community Clean-Up—Bonding over nature
Poetry Reading—Discussing performances over coffee
Book Club—Talking about a recent novel
Game Night—Teaming up in a board game
Outdoor Concert—Chatting about favorite bands
Art Class—Sharing creative tips
Block Party—Swapping family recipes at a barbecue
Science Fair—Engaging conversation about innovation
Community Garden—Planting and sharing gardening tips
Cooking Workshop—Learning a recipe together
Charity Run—Encouraging each other while jogging
Craft Fair—Talking about DIY projects
Food Truck—Bonding over shared cravings
Community Brunch—Chatting about seasonal dishes
Open Mic Night—Discussing favorite performances
Craft Store—Reaching for the same quirky item

For the preparation phase, stylist examples of target artwork style can be selected. The examples can be diverse, ranging from cartoony to cyberpunky. In some specific examples, a computer model or AI can be used to describe the style of the artwork. Sample images in various styles can be generated, potentially reducing to just six styles based on the quality of generated artwork. The final styles can be described in a single word, such as (1) whimsical, (2) cinematic, (3) glowing, (4) serene, (5) bold, (6) retro, although the actual description prompts can be about 100 words.

The generation phase can include producing candidate images for combinations of character gender, scenario, and style. Some scenarios share the same short description, e.g. “cooking,” so one set of images may be generated for those scenarios. Because the process can take substantial time to generate each image, the process to generate each image can run concurrently to generate 4 sets of images in parallel. Image generation can include two AI operations. The first operation uses a prompt to rewrite the scenario description in the style of a famous romance novelist, so that it is describing how the player may have first seen the AI in this encounter. The language model can add text details which then become visual variations in the image generation invocation. The image generation itself is performed by concatenating the verbal description with the style description.

In the second operation, images can be reviewed and deleted if they do not focus well on the digital character, conform too frequently to probabilistically incorrect details, show incorrect gender of the digital character, or more commonly just because they don't stay very true to a playful style.

Once styles are sourced, candidates created, undesirables filtered, and image cleanups are applied, the final phase is tagging the images with how they should be cropped. This can be done by an administrator, a vision-language model (VLM), or some other means.

In some examples, the user has a limited time to secure a date or ask to exchange contact information of the digital character. In some ways, this experience mimics real-life where a user would have only a short time to make a first impression. Instead of limits by rounds of back-and-forth, which could vary based on the conversation, the system can use the cost limit of the language model interaction as the source for the timer. The cost time limit can depend on duration of pauses or how much input or output speech goes into the model. The system uses the costs reported to compute a progress from 0-100%, with the player losing unless they scored a date in their final request. The system can make an effort to give the use a textual hint on the last turn before they run out of time, however, this timing is approximate. In some implementations, the user does not receive a hint, particularly if they have a long back-and-forth at the end of the conversation. Generally speaking, sessions of 2-3 minutes of talk time can be expected.

At the end of the session, the points the user has earned can be aggregated during the session. Based on the number of points that the user earned per back and forth, their final “FIRES” score is determined. In a non-limiting example:
No date, offensive, etc.—0 fires
Got a date, less 2 points/round—1 fires
Got a date, 3 points/round—2 fires
Got a date 4.5 points/round—3 fires

In a specific non-limiting example when the user begins a session, a live audio session is initialized, a real-time API is sent a prompt to begin the session and will start talking to the user. As the user responds, each round can be evaluated by the API to evaluate the user's response. A “score” for the response is calculated (see below). The session can be facilitated through the LiveKit software development kit (SDK), which enables access to the WebRTC layer for a real-time audio session.

On screen, the user can be presented with round-by-round scores, a total score as represented by fires, flames, or some other indicator, a progress bar that gives some indication about how much approximate time is remaining in the session, and an AI generated illustration that represents the digital character.

The round-by-round scoring methodology can be a simple scoring criterion of −5 to +5 on 2-3 of the below categories per round.
1. *Allure*—Assess the level of charm and flirtation displayed.
2. *Wit*—Evaluate the use of humor and cleverness.
3. *Empathy*—Measure the display of understanding and emotional intelligence.
4. *Confidence*—Assess self-assurance and initiative.
5. *Creativity*—Evaluate originality and inventiveness in the conversation.
6. *Courtesy*—Assess politeness and respect towards the other person.
7. *Connection*—Measure the ability to build rapport and establish a connection.
8. *Flexibility*—Evaluate adaptability and responsiveness in the conversation.

The system can determine the user is not earning any points. If a user gets less than 1 point in a round, the system can generate a dynamic hint based on the conversation (e.g., using a mini model). The game prompt is designed to make funny or sarcastic comments for hints, with a preference to be more extreme if the same hint needs to be repeated. Hints can be short, e.g., 7-15 words.

There can be pre-configured static first time hints (e.g., Try asking X out on a date, Get X's digits before you leave, Make plans to see X again, etc.) that may be delivered before the user says anything so the objective of the scenario is clear to the user. In many implementations, the first-time hints are not good to follow directly, as the user will need to build some rapport with the digital character first, and often the digital character would rebuff the user with an immediate approach to complete the objective.

The LiveKit agent framework can be used to provide the core audio connectivity part of the product experience.

The personality of the digital character can be determined randomly. In some examples models and frameworks for human behavior (e.g., personality traits, tendencies (e.g., regional tendencies), flirting styles, etc.) can be layered into the AI personality. For example, in some instances, the AI personality can be a set of Big 5 personality traits or some other personality traits of either low or high. The Big 5 personality traits or values are commonly understood to be openness, conscientiousness, extraversion, agreeableness, and neuroticism. Note that other personality traits may be used for the digital character. In some examples, the character prompt can be further instruct the language model to adapt a flirting style for the digital character, such as polite, traditional, sincere, playful, physical, or some other flirting style. Nonetheless, the digital character can have some of this personality hidden behind the initial reaction to the scenario in harder difficulty scenarios, so it may not be observable until later in the conversation.

Because the experience can be a funny improv style experience, the personality prompts also include a comic's style to adopt, if and when appropriate. There can be at least one comedian for an accent. These comedians can be selected by a human or a language model, based on the respective comedian speaking with the corresponding accent.

If a scenario only makes sense in a certain location, like skiing, then the system can pick randomly from a list of five locations picked for that scenario. If the scenario is not geography-specific, then the system can select a random location from a list of five likely locations where the accent of the digital character is likely to be heard.

Metadata related to the session can be stored for analysis. More specifically, for a session, a text transcript of the session, agent generated information like the scoring calculation, judgments of each round, hints provided to the user, the scenario variables for a given round, technical information like a sessionID, token usage and the prompts used, can be saved.

In a specific example, monitoring of server-side metrics can be performed in real-time. Implementations can export a number of specific application-level metrics that can be watched for cost and some rough behavior measurements. For auto-scaling/health, standard CPU usage metrics and the active sessions counters can be watched and observed from the APM metrics. The number of sessions or scenarios per day per user is configurable and can be updated within seconds on the backend.

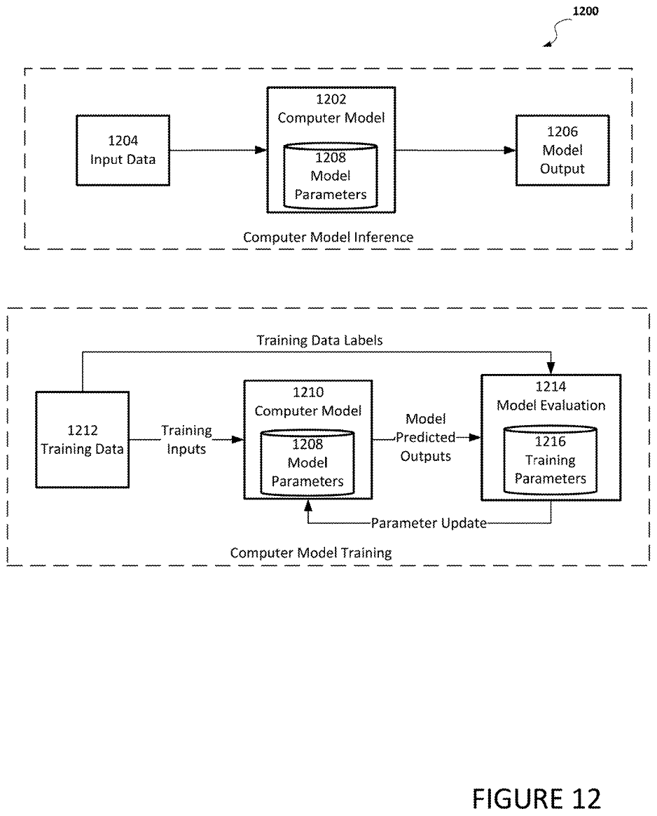

Turning to FIG. 12, FIG. 12 illustrates example computer model inference and computer model training 1200. Computer model inference refers to the application of a computer model 1202 to a set of input data 1204 to generate an output or model output 1206. The computer model 1202 determines the model output 1206 based on parameters of the model, also referred to as model parameters 1208. The parameters of the model may be determined based on a training process that finds an optimization of the model parameters 1208, typically using training data and desired outputs of the model for the respective training data as discussed below. The output (e.g., an AI to engage in a hypothetical scenario) of the computer model 1202 may be referred to as an “inference” because it is a predictive value based on the input data 1204 and based on previous example data used in the model training.

The input data 1204 and the model output 1206 vary according to the particular use case. For example, to create an AI to engage in a hypothetical scenario, the input data 1204 may be data from participants in one or more scenarios and the output or “inference” may be a set of responses that correspond to the scenario.

In an illustrative example to determine the rizz of a user, speech recognition (ASR), natural language processing (NLP), sentiment analysis, etc. can be used to analyze communications for keywords, sentiment, and patterns.

Additional processing for input objects may themselves be learned representations of data, such that another computer model processes the input objects to generate an output that is used as the input data 1204 for the computer model 1202. Although not further discussed here, such further computer models may be independently or jointly trained with the computer model 1202. As noted above, the model output 1206 may depend on the particular application of the computer model 1202.

The computer model 1202 includes various model parameters 1208, as noted above, that describe the characteristics and functions that generate the model output 1206 from the input data 1204. In particular, the model parameters 1208 may include a model structure, model weights, and a model execution environment. The model structure may include, for example, the particular type of computer model 1202 and its structure and organization. For example, the model structure may designate a neural network, which may be comprised of multiple layers, and the model parameters 1208 may describe individual types of layers included in the neural network and the connections between layers (e.g., the output of which layers constitute inputs to which other layers). Such networks may include, for example, feature extraction layers, convolutional layers, pooling/dimensional reduction layers, activation layers, output/predictive layers, and so forth. While in some instances the model structure may be determined by a designer of the computer model, in other examples, the model structure itself may be learned via a training process and may thus form certain “model parameters” of the model.

The model weights may represent the values with which the computer model 1202 processes the input data 1204 to the model output 1206. Each portion or layer of the computer model 1202 may have such weights. For example, weights may be used to determine values for processing inputs to determine outputs at a particular portion of a model. Stated another way, for example, model weights may describe how to combine or manipulate values of the input data 1204 or thresholds for determining activations as output for a model. As one example, a convolutional layer typically includes a set of convolutional “weights,” also termed a convolutional kernel, to be applied to a set of inputs to that layer. These are subsequently combined, typically along with a “bias” parameter, and weights for other transformations to generate an output for the convolutional layer.

The model execution parameters represent parameters describing the execution conditions for the model. In particular, portions of the model may be implemented on various types of hardware or circuitry for executing the computer model 1202. For example, portions of the model may be implemented in various types of circuitry, such as general-purpose circuitry (e.g., a general CPU), circuitry specialized for certain functions (e.g., a GPU or programmable Multiply-and-Accumulate circuit) or circuitry specially designed for the particular computer model application. In some configurations, different portions of the computer model 1202 may be implemented on different types of circuitries. As discussed below, training of the model may include optimizing the types of hardware used for certain portions of the computer model 1202 (e.g., co-trained), or may be determined after other parameters for the computer model 1202 are determined without regard to configuration executing the model. In another example, the execution parameters may also determine or limit the types of processes or functions available at different portions of the model, such as value ranges available at certain points in the processes, operations available for performing a task, and so forth.

Computer model training may thus be used to determine or “train” the values of the model parameters 1208 for the computer model 1210. During training, the model parameters 1208 are optimized to “learn” values of the model parameters (such as individual weights, activation values, model execution environment, etc.), that improve the model parameters 1208 based on an optimization function that seeks to improve a cost function (also sometimes termed a loss function). Before training, the computer model 1210 has model parameters 1208 that have initial values that may be selected in various ways, such as by a randomized initialization, initial values selected based on other or similar computer models, or by other means. During training, the model parameters are modified based on the optimization function to improve the cost/loss function relative to the prior model parameters.

In many applications, training data 1214 includes a data set to be used for training the computer model 1210. The data set varies according to the particular application and purpose of the computer model 1210. In supervised learning tasks, the training data 1212 typically includes a set of training data labels that describe the training data 1212 and the desired output of the model relative to the training data 1212.

To train the computer model 1210, a training module (not shown) applies the training inputs to the computer model 1210 to determine the outputs predicted by the model for the given training inputs. The training module, though not shown, is a computing module used for performing the training of the computer model 1210 by executing the computer model 1210 according to its inputs and outputs given the model's parameters and modifying the model parameters based on the results. The training module may apply the actual execution environment of the computer model 1210, or may simulate the results of the execution environment, for example to estimate the performance, runtime, memory, or circuit area (e.g., if specialized hardware is used) of the computer model 1210. The training module, along with the training data 1212 and model evaluation, may be instantiated in software and/or hardware by one or more processing devices. In various examples, the training process may also be performed by multiple computing systems in conjunction with one another, such as distributed/cloud computing systems. In some examples the training of the computer module 1210 may be different if the computer model 1210 is a large language model (LLM) used for automated message responses as compared to being used to simulate a scenario where the user is attempting to determine the charisma/charm or rizz of the user. A large language model is used for language-based tasks, whereas the general AI model or computer model can be used for a variety of other tasks, including to determine the charisma/charm or rizz of a user.

After processing the training inputs according to the current model parameters for the computer model 1210, the model's predicted outputs are evaluated and the computer model 1210 is evaluated with respect to the cost function and optimized using an optimization function of the training model. Depending on the optimization function, particular training process and training parameters 1216 after the model evaluation are updated to improve the optimization function of the computer model 1210. In supervised training (i.e., training data labels are available), the cost function may evaluate the model's predicted outputs relative to the training data labels and to evaluate the relative cost or loss of the prediction relative to the “known” labels for the data. This provides a measure of the frequency of correct predictions by the computer model 1210 and may be measured in various ways, such as the precision (frequency of false positives) and recall (frequency of false negatives). The cost function in some circumstances may also evaluate other characteristics of the model, for example the model complexity, processing speed, memory requirements, physical circuit characteristics (e.g., power requirements, circuit throughput) and other characteristics of the computer model 1210 structure and execution environment (e.g., to evaluate or modify these model parameters).

After determining results of the cost function, the optimization function determines a modification of the model parameters to improve the cost function for the training data 1212. Many such optimization functions are known to one skilled in the art. Many such approaches differentiate the cost function with respect to the parameters of the model and determine modifications to the model parameters that thus improves the cost function. The parameters for the optimization function, including algorithms for modifying the model parameters are the training parameters 1216 for the optimization function. For example, the optimization algorithm may use gradient descent (or its variants), momentum-based optimization, or other optimization approaches used in the art and as appropriate for the particular use of the model. The optimization algorithm thus determines the parameter updates to the model parameters. In some implementations, the training data 1212 is batched and the parameter updates are iteratively applied to batches of the training data 1212. For example, the model parameters may be initialized, then applied to a first batch of data to determine a first modification to the model parameters. The second batch of data may then be evaluated with the modified model parameters to determine a second modification to the model parameters, and so forth, until a stopping point, typically based on either the amount of training data 1212 available or the incremental improvements in model parameters are below a threshold (e.g., additional training data 1212 no longer continues to improve the model parameters). Additional training parameters 1216 may describe the batch size for the training data 1212, a portion of training data 1212 to use as validation data, the step size of parameter updates, a learning rate of the model, and so forth. Additional techniques may also be used to determine global optimums or address nondifferentiable model parameter spaces.

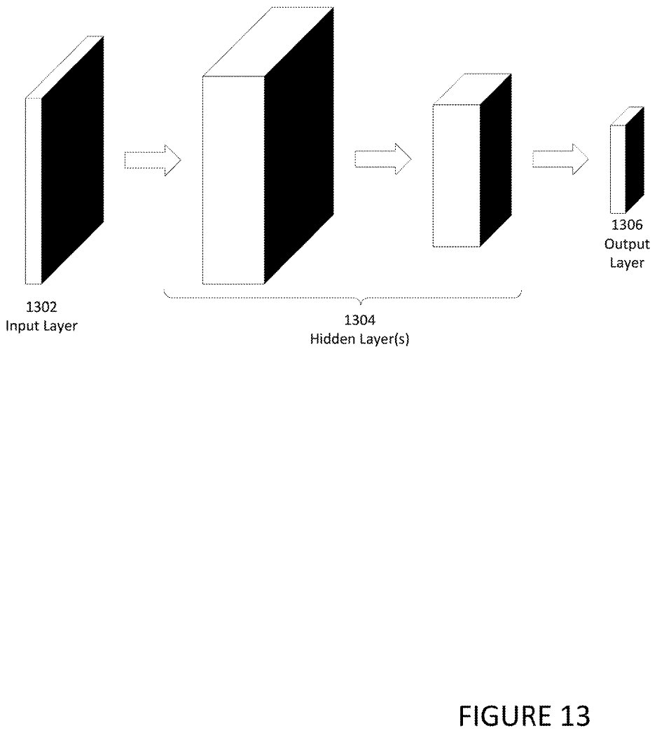

Turning to FIG. 13, FIG. 13 illustrates an example neural network architecture. In general, a neural network includes an input layer 1302, one or more hidden layers 1304, and an output layer 1306. The values for data in each layer of the network are generally determined based on one or more prior layers of the network. Each layer of a network generates a set of values, termed “activations” that represent the output values of that layer of a network and may be the input to the next layer of the network. For the input layer 1302, the activations are typically the values of the input data, although the input layer 1302 may represent input data as modified through one or more transformations to generate representations of the input data. For example, in recommendation systems, interactions between users and objects may be represented as a sparse matrix. Individual users or objects may then be represented as an input layer 1302 as a transformation of the data in the sparse matrix relevant to that user or object. The neural network may also receive the output of another computer model (or several), as its input layer 1302, such that the input layer 1302 of the neural network shown in FIG. 13 is the output of another computer model. Accordingly, each layer may receive a set of inputs, also termed “input activations,” representing activations of one or more prior layers of the network and generate a set of outputs, also termed “output activations” representing the activation of that layer of the network. Stated another way, one layer's output activations become the input activations of another layer of the network, except for the final output layer of 1306 of the network.

Each layer of the neural network typically represents its output activations (i.e., also termed its outputs) in a matrix, which may be 1, 2, 3, or n-dimensional according to the particular structure of the network. As shown in FIG. 13, the dimensionality of each layer may differ according to the design of each layer. The dimensionality of the output layer 1306 depends on the characteristics of the prediction made by the model. For example, a computer model for multi-object classification may generate an output layer 1306 having a one-dimensional array in which each position in the array represents the likelihood of a different classification for the input layer 1302. In another example for classification of portions of an image, the input layer 1302 may be an image having a resolution, such as 512×512, and the output layer may be a 512×512×n matrix in which the output layer 1306 provides n classification predictions for each of the input pixels, such that the corresponding position of each pixel in the input layer 1302 in the output layer 1306 is an n-dimensional array corresponding to the classification predictions for that pixel.

The hidden layers 1304 provide output activations that variously characterize the input layer 1302 in various ways that assist in effectively generating the output layer 1306. The hidden layers thus may be considered to provide additional features or characteristics of the input layer 1302. Though two hidden layers are shown in FIG. 13, in practice any number of hidden layers may be provided in various neural network structures.

Each layer generally determines the output activation values of positions in its activation matrix based on the output activations of one or more previous layers of the neural network (which may be considered input activations to the layer being evaluated). Each layer applies a function to the input activations to generate its activations. Such layers may include fully-connected layers (e.g., every input is connected to every output of a layer), convolutional layers, deconvolutional layers, pooling layers, and recurrent layers. Various types of functions may be applied by a layer, including linear combinations, convolutional kernels, activation functions, pooling, and so forth. The parameters of a layer's function are used to determine output activations for a layer from the layer's activation inputs and are typically modified during the model training process. The parameters describing the contribution of a particular portion of a prior layer is typically termed a weight. For example, in some layers, the function is a multiplication of each input with a respective weight to determine the activations for that layer. For a neural network, the parameters for the model as a whole thus may include the parameters for each of the individual layers and in large-scale networks can include hundreds of thousands, millions, or more of different parameters.

As one example for training a neural network, the cost function is evaluated at the output layer 1306. To determine modifications of the parameters for each layer, the parameters of each prior layer may be evaluated to determine respective modifications. In one example, the cost function (or “error”) is backpropagated such that the parameters are evaluated by the optimization algorithm for each layer in sequence, until the input layer 1302 is reached.

In the description, various examples of the illustrative implementations are described using terms commonly employed by those skilled in the art to convey the substance of their work to others skilled in the art. However, the embodiments disclosed herein may be practiced with only some of the described examples. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments. The terms “substantially,” “close,” “approximately,” “near,” and “about,” generally refer to being within +/−20% of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Substantial flexibility is provided by the system, apparatus, and a method to enable a gamified single player charisma and/or charm evaluation in that any suitable arrangements, chronologies, configurations, and timing mechanisms may be provided without departing from the teachings of the present disclosure.

Note that embodiments of the electronic devices 102, charisma/charm engine 104, data receiving engine 108, the image and scene engine 110, the scenario engine 112, the conversation engine 114, the monitoring engine 116, the suggestion/tips engine 118, the progress engine 120, the scoring engine 122, and the summary and tip engine 124, may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces, may include physical ports (e.g., Ethernet, USB, HDMI, etc.), interfaces for wired and wireless internal subsystems, and the like. Similarly, each of the electronic devices 102, charisma/charm engine 104, data receiving engine 108, the image and scene engine 110, the scenario engine 112, the conversation engine 114, the monitoring engine 116, the suggestion/tips engine 118, the progress engine 120, the scoring engine 122, and the summary and tip engine 124 can also include suitable interfaces for receiving, transmitting, and/or otherwise communicating data or information in a network environment.

The electronic devices 102, charisma/charm engine 104, data receiving engine 108, the image and scene engine 110, the scenario engine 112, the conversation engine 114, the monitoring engine 116, the suggestion/tips engine 118, the progress engine 120, the scoring engine 122, the summary and tip engine 124, and other associated or integrated components can include one or more memory elements for storing information to be used in achieving operations associated with a gamified single player charisma and/or charm evaluation, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in the system could be provided in any database, register, table, cache, queue, control list, or storage structure, based on particular needs and implementations, all of which could be referenced in any suitable timeframe. Any of the memory or storage options discussed herein should be construed as being encompassed within the broad term ‘memory element’ as used herein in this Specification.

In example embodiments, the operations for enabling a gamified single player charisma and/or charm evaluation, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements can store data used for the operations described herein. This includes the memory elements being able to store software, logic, code, or processor instructions that are executed to carry out a gamified single player charisma and/or charm evaluation described in this Specification. Regarding a physical implementation of the electronic devices 102, charisma/charm engine 104, data receiving engine 108, the image and scene engine 110, the scenario engine 112, the conversation engine 114, the monitoring engine 116, the suggestion/tips engine 118, the progress engine 120, the scoring engine 122, the summary and tip engine 124, and their associated components, any suitable permutation may be applied based on particular needs and requirements.

Note that with the examples provided herein, interaction may be described in terms of one, two, three, or more elements. However, this has been done for purposes of clarity and example only. In certain cases, it may be easier to describe one or more of the functionalities by only referencing a limited number of elements. The system, apparatus, and a method to enable a gamified single player charisma and/or charm evaluation and their teachings are readily scalable and can accommodate a large number of components, as well as more complicated/sophisticated arrangements and configurations. Accordingly, the examples provided should not limit the scope or inhibit the broad teachings of the system, apparatus, and method to enable a gamified single player charisma and/or charm evaluation and as potentially applied to a myriad of other architectures.

The operations in the preceding flow diagrams (i.e., FIGS. 8-11) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the system and method have been illustrated with reference to particular elements and operations, these elements and operations may be replaced by any suitable architecture, protocols, and/or processes that achieve the intended functionality of the system and method. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

### EXAMPLES

In Example JM1, a method includes creating a scenario for a user, wherein the user engages in conversation with an AI generated persona; monitoring the user's interaction with the AI generated persona; and determining charisma and/or charm of the user based on the monitored user's interaction with the AI generated persona.

Example JM2 is the method of Example JM1, wherein the objective of the scenario is for the user to get the AI generated persona to agree to a date.

Example JM3 is the method of Example JM2, wherein the scenario for the user is created inside a dating application to help determine the charisma and/or charm of the user.

In Example JS1, a system includes memory; at least one processor; and a charisma/charm engine configured to create a scenario for a user, wherein the user engages in conversation with an AI generated persona; monitor the user's interaction with the AI generated persona; and determine a charisma and/or charm of the user based on the monitored user's interaction with the AI generated persona.

Example JS2 is the system of Example JS1, further comprising: an image and scene engine to generate an avatar and scene for the scenario; a scenario engine configured to create the scenario; a conversation engine configured to engage in conversation or dialog with the user; a monitoring engine configured to monitor the conversation or dialog with the user; a suggestion/tips engine configured to monitor the progress of the user during the conversation and provide suggestions or tips to the user on how to improve their charisma/charm or rizz; a progress engine configured to monitor the progress of the user during the conversation and provide real time or near real time feedback to the user; a scoring engine configured to monitor the progress of the user during the conversation or dialog and determine a score or level that summarizes how well the user did during the conversation; and a summary and tip engine configured to monitor the progress of the user during the conversation or dialog and, at the conclusion of the conversation or dialog, provide a summary of how well the user performed and provide feedback or tips for the user to improve their performance.

What is claimed is:

1. A method, comprising:
inputting a goal into a language model;
receiving a user registration for an online dating service, the user registration indicating a gender of interest for a user;
receiving a user input from the user;
receiving a model output from the language model, at least in part based on the user input, the gender of interest, and the goal;
determining whether the goal was achieved within a predetermined duration, at least in part based on the model output; and
producing feedback for the user, at least in part based on the goal and the user input.

2. The method of claim 1, further comprising:
determining at least one attribute of a location, a persona, a job, an age, or a scenario, wherein the model output is further based at least in part on the at least one attribute.

3. The method of claim 2, wherein at least one attribute is determined randomly.

4. The method of claim 1, wherein the receiving the model output is performed, at least in part based on a determination that a predetermined duration of a round has expired or that the user input was received.

5. The method of claim 1, wherein the goal is to accept a date from the user.

6. The method of claim 1, wherein the feedback includes a score or a tip to achieve the goal.

7. The method of claim 1, further comprising:
producing a text input, based on the user input, wherein the user input is received via a microphone, and the determining is performed at least in part based on the text input; and
producing an audio output, at least in part based on the model output.

8. An apparatus, comprising:
a network interface that inputs a game prompt including a goal into a language model, wherein
the network interface receives a user registration for an online dating service and transmits a character prompt to the language model, the character prompt indicating a gender of interest for a user, the user registration indicating the gender of interest, and
the network interface receives a user input from the user and transmits the user input to the language model,
the network interface receives a model output from the language model, at least in part based on the user input, the gender of interest, and the game prompt,
the user interface transmits feedback for the user, and
the user interface receives a second user input; and
a processor configured to determine whether the goal was achieved within a predetermined duration, at least in part based on the model output and the second user input.

9. The apparatus of claim 8, wherein the processor is further configured to determine at least one attribute of a location, a persona, a job, an age, or a scenario, the character prompt includes the at least one attribute, and the model output is further based at least in part on the at least one attribute.

10. The apparatus of claim 8, wherein the at least one attribute is determined randomly.

11. The apparatus of claim 8, wherein the model output is received, at least in part based on a determination that a predetermined duration of a round has expired or that the user input was received.

12. The apparatus of claim 8, wherein the goal is to accept a date from the user.

13. The apparatus of claim 8, wherein the feedback includes a score or a tip to achieve the goal.

14. The apparatus of claim 8, wherein the processor is further configured to produce a text input, based on the user input, the user input received via a microphone, to determine whether the goal was achieved at least in part based on the text input, and to produce an audio output, at least in part based on the model output.

15. A computer-readable medium encoded with executable instructions that, when executed by a processor, perform operations comprising:
determining whether a goal was achieved within a predetermined duration, at least in part based on a model output and a second user input, wherein
a game prompt including a goal is input into a language model,
a user registration for an online dating service is received, the user registration indicating a gender of interest for a user,
a character prompt is transmitted to the language model, the character prompt indicating the gender of interest, and
a user input from the user is received and is transmitted to the language model,
a model output is received from the language model, at least in part based on the user input, the gender of interest, and the game prompt,
the user interface transmits feedback for the user, and
the user interface receives the second user input.

16. The medium of claim 15, the operations further comprising:
determining at least one attribute of a location, a persona, a job, an age, or a scenario, the character prompt includes the at least one attribute, and the model output is further based at least in part on the at least one attribute.

17. The medium of claim 15, wherein the model output is received, at least in part based on a determination that a predetermined duration of a round has expired or that the user input was received.

18. The medium of claim 15, wherein the goal is to accept a date from the user.

19. The medium of claim 15, wherein the feedback includes a score or a tip to achieve the goal.

20. The medium of claim 15, the operations further comprising:
producing a text input, based on the user input, the user input received via a microphone;
determining whether the goal was achieved at least in part based on the text input; and
producing an audio output, at least in part based on the model output.
